(19) United States
(12) Patent Application Publication
(10) Pub. No.: US 2008/0098127 A1
(43) Pub. Date: Apr. 24, 2008

(54) Method and Network Element for Rerouting Traffic, While Maintaining the Quality of Service, in Networks with Slow Route Convergence

(76) Inventor: Thomas Engel, Unterbiberg (DE)

Correspondence Address: John P Musone;Siemens Corporation, Intellectual Property Department, 170 Wood Avenue South, Iselin, NJ, 08830, US

(21) Appl. No.: 11/632,903

(22) PCT Filed: Jul. 29, 2005
(86) PCT No.: PCT/EP05/53718

§ 371 Date: Jan. 19, 2007

(30) Foreign Application Priority Data
Jul. 30, 2004 (DE) 10 2004 037 024.9

(51) Int. Cl. G06F 15/173

(52) U.S. Cl. 709/238

(57) ABSTRACT

A route for routing traffic is established by the emission of a route announcing message to a network element of a network. The network element is then triggered in such a way as to route the traffic according to the route announced in a time-delayed manner by means of an event e.g. the emission of another message. A resource reservation for routing traffic along the announced route is carried out between the route announced and the event. In this way, it is ensured that the required resources are provided for the deviation of traffic onto the new route, and a route modification for traffic can be carried out without affecting the quality of service.

### CROSS REFERENCE TO RELATED APPLICATIONS

This application is the US National Stage of International Application No. PCT/EP2005/053718, filed Jul. 29, 2005 and claims the benefit thereof. The International Application claims the benefits of German application No. 10 2004 037 024.9 DE filed Jul. 30, 2004, both of the applications are incorporated by reference herein in their entirety.

### FIELD OF INVENTION

The invention relates to a method for defining a route for the routing of traffic and to a network element with means for executing such a method.

### BACKGROUND OF INVENTION

A currently very topical field of activity in the area of networks and network technologies is the further development of data networks for the transmission of real-time traffic while maintaining quality-of-service features.

In future data networks, of which the most important representatives are IP (Internet Protocol) networks, are to support applications which include the transmission of voice, video and data streams in real time. A fast and reliable transport of data packets or IP packets must be guaranteed for such applications. For this purpose future IP networks—alongside the traditional “best effort” services for data transmission—should offer new transmission services which provide the necessary bandwidths from end to end and reliably transfer to the recipient IP packets with small, barely-fluctuating delay and very low packet loss rates (i.e. while maintaining quality-of-service features). These new services will be referred to below as QoS services (QoS: Quality of Service) and the traffic transported by them as QoS traffic.

Since the Internet is a combination of a growing number of individual IP networks, referred to as autonomous systems (AS), which are administered and controlled by different organizations, QoS services must be realized and made available in this internetwork to provide cross-network coverage. To achieve this end resource management systems which provide the resources necessary for the assured quality of service to the QoS traffic across the different networks are generally employed. For various reasons, such as traffic engineering and changes to networks and business relationships, cross-network traffic is frequently diverted on to new cross-network routes. The cross-network routing along routes from individual networks or autonomous systems is frequently also referred to as inter-domain routing.

The interaction of autonomous systems in the Internet, i.e. the cross-network forwarding of IP packets across the boundaries of individual IP networks, is controlled by the inter-domain routing protocol BGP (BGP: Border Gateway Protocol) (described in RFC1771). To this end adjacent border routers establish what are known as BGP peering sessions and exchange routing information via what are known as UPDATE messages. A network uses BGP to learn which IP addresses are accessible via which routes. Routes in this case are routes between networks at the level of autonomous systems and are encoded as sequences of AS (Autonomous System) numbers. Autonomous systems are assigned unique AS numbers for this purpose. If traffic is to be diverted onto a new route a border router announces a change in route by means of an UPDATE message (announcement of the new route, or withdrawal of an existing route, or both). This type of change in route is generally broadcast from network to network across many networks using further UPDATE messages. Networks further away generally receive a number of UPDATE messages via a number of routes and see different routes from which they select the best route from their standpoint. This means that a convergence process is started with the first UPDATE which has been measured as lasting around three minutes on average. During the convergence time the traffic affected is as a rule diverted numerous times to changing routes which means that significant delays of IP packets and high packet loss rates have to be expected.

Resource management systems and signaling protocols, such as BGRP (BGRP: Border Gateway Reservation Protocol) for example, are used for the provision and administration of the resources needed for QoS services. Resource Management reserves the necessary resources along the routes provided by the BGP protocol. A resource reservation must then follow the route changes initiated by the BGP protocol, i.e. when a route is changed a correspondingly changed reservation must be undertaken. This causes major problems, above all during the convergence time in which a network is looking for a new stable route from a number of routes. Routes selected in the interim are not immediately recognizable as intermediate solutions. If the route changes are followed rapidly by resource management then resources are reserved several times for the same traffic. If resource management waits for convergence the assured quality of service of the QoS traffic can be damaged in the long term.

### SUMMARY OF INVENTION

An object of the invention is to specify an optimized method for defining routes while maintaining quality-of-service features.

The object is achieved by a method as claimed in the independent claims.

The invention is based on the idea, when defining a route, e.g. within the framework of a route change or a notification of a new route, of only announcing this route before it is put into service or activated after a delay, e.g. by making a corresponding entry in a routing table. In this case the announcement of the route preferably consists of communicating the future route. It is for example also possible to reference within the framework of the announcement a route already reserved as an alternate in order to bring about the activation of the route in this way.

The invention is primarily intended to overcome the problems which arise during the definition of inter-domain routes, e.g. by means of the BGP protocol, caused by the comparatively slow convergence during the determination or specification of new or changed routes. These slow convergence times are above all a problem in the transmission of real-time traffic. As part of the inventive method the route is first announced and is later activated after a time delay.

In the meantime a convergence in respect of the new or changed route can be undertaken, i.e. the optimum route in the sense of a metric is selected from a number of announced routes to the same destination and a resource reservation along this optimum route can be undertaken. In this way the necessary resources are available when the route is activated. The traffic to be transported, especially QoS traffic, can be diverted without any adverse effects. It is conceivable for the inventive method and the conventional procedures to be used in parallel, with the inventive method being employed if QoS traffic is involved.

Planned route changes, i.e. rerouting necessary because of line and node outages, can be executed with the inventive method without disturbing the assured quality of service for the QoS traffic. The method thus increases the availability of QoS services and simplifies resource management. The quality of service of QoS services in the planned rerouting of cross-network traffic streams can be safeguarded in this way. In particular this supports traffic engineering of cross-network traffic which even today is an increasingly significant practice among network operators.

Even if the invention is aimed primarily at remedying the problems arising in inter-domain routing in data networks, the inventive idea is not restricted to this case. It is immediately evident to the person skilled in the art that the inventive procedures can be employed in any communication networks in which problematic delays occur in the definition of new or modified routes. In particular the inventive method can also be employed in intra-domain routing if difficulties arise for similar reasons in respect of convergence times in the Intra-domain routing.

The event which causes the new route to be put into operation or activates the new route is preferably specified by the sending of a route activation message, also simply referred to as activation below. A network element which puts a new route into operation then receives two different messages delayed in relation to each other; one to announce the change of route, the second to activate this route change. The event which initiates the putting into operation could however also take another form, it being conceivable for example for a network element to start a timer or timers after receiving a route modification message and to initiate the putting into operation after this timer times out. A route activation message can be provided by an UPDATE message of the BGP protocol for example.

Resources are preferably reserved between the receipt of the route announcement message and the activation of the route. This resource reservation may possibly precede a selection of an optimum route. The reservation of resources for the new route (which may have been identified as the optimum one) can for example be implemented with the aid of a resource reservation message which is sent to a resource management entity. The address of this resource management entity can have been communicated by means of a route announcing message to the network element responsible for route definition. The resource management entities affected by resource reservations are localized in a preferred embodiment along the route to be defined. In this case a resource reservation message is transmitted from the network element along a route which was set up when the resource announcing message was processed, which corresponds to the new route in its course and allows reservation messages to be sent without affecting existing traffic. To this end the route is preferably created, when the resource announcing message is processed, with a prefix which is notified by the resource announcing message and contains an address of the resource manager in the system which has originally initiated the route announcing. A message can be propagated in this way along at the entire route, alternatively the routing entities lying on the new route for their part send resource reservation messages to assigned resource management entities to guarantee a resource reservation along the entire route. Since resource reservation messages can run in the opposite direction on the path from route announcing messages, the assignment of a resource management entity can easily be derived from the route announcement message.

In accordance with a further development of the object of the application a successful resource reservation can be confirmed to the network element responsible for defining the route. The activation of the route can be made dependent on the prior receipt of a confirmation of the reservation, i.e. the activation is not undertaken unless a confirmation for the resource reservation is available. Alternatively, if a route reservation fails, the arrival of the activation can be prevented, e.g. by a route activation message not being sent to the network element. Furthermore the activation can be made dependent on the resource manager specified in the route announcing messages receiving, as a reaction to its announcement, reservations for which the total resource requirements lie within one period of time.

The route announcing message preferably contains a code or attribute which identifies it as an announcing message. Information about the time of arrival of the event, e.g. the time of the sending of a route activation message, can be transferred with this announcing message. This information can consist both of a time difference between the announcing message and the event triggering the activation, and also of an absolute point in time of the planned arrival of the event of the activation. In the latter case it is desirable to synchronize the clocks of the sender of the message and the recipient, i.e. the network element, which for example can be achieved using the NTP (Network Time Protocol) protocol (described in RFC1305). The route announcing message can essentially take the form of a BGP UPDATE message, in which case it is modified in relation to conventional UPDATE messages at least to the extent that it should include a code identifying it as an announcing message. It can comprise information about the arrival of the time and an address of a resource management entity responsible, which also represents an expansion with respect to conventional UPDATE messages.

The inventive method then executes as follows in a preferred embodiment realized by means of UPDATE messages. Advance announcements of route changes are triggered by traffic engineering and other planned traffic diversions. If in future current traffic is to reach an autonomous system A via another border router R2 instead of via a border router R1, i.e. is to be routed via new paths, then the border router R2 to be used in the future sends a BGP UPDATE message in the conventional manner to the neighbors involved. By contrast with the previous execution sequence however, it sends an UPDATE message U1 with an advance announcement of the new route. Later, at an announced time, R2 sends a second regular UPDATE message U2 with the new route announced in U1. The UPDATE message U1 announces U2 and gives the networks involved the opportunity, without disturbing current traffic, of running through the convergence process beforehand, reserving the required resources on the new convergent route and diverting the traffic involved with the propagation of U2 without any problems in one step onto a prepared route. To this end new attributes are inserted into UPDATE messages in accordance with RFC 1771: for the identification of announcements, for the notification of the transmit time of U2 and for the notification of the address of a resource manager in A to which reservations for the announced route are to be sent. Like a regular UPDATE message, an announcement also contains a route consisting of a prefix P, a route R encoded in a list of AS numbers and attributes. The prefix P, route R and attributes are identical to those in U2.

Possible variants of this preferred embodiment are: The border router R2 could send an announcement U1 without specifying the time of the planned sending of the actual UPDATE message U2 and simply wait for an appropriate length of time before U2 is sent (estimates about distribution of the route lengths) and a reacting AS could likewise wait for an appropriate period of time for the signaling for resource reservation (estimates about distribution of the route lengths). Alternatively U1 could contain a time interval instead of a point in time which is adapted from border router to border router (deduction of forwarding and processing time) and which displays the remaining time until U2 is sent out. As an optional improvement the UPDATE U2 can contain a reference to U1 and facilitate the linkage with the announced route change.

The object of the invention also includes a network element with means for executing a method in the sense of the inventive procedure.

### BRIEF DESCRIPTION OF THE DRAWINGS

The invention is explained in greater detail below within the context of an exemplary embodiment with reference to Figures. The figures show:

FIG. 1: a section of an internetwork which is formed by autonomous systems (AS).

FIG. 2 and FIG. 3: a flowchart for executing an inventive method.

### DETAILED DESCRIPTION OF INVENTION

Within the framework of the exemplary embodiment, route changes during inter-domain routing are announced by means of the BGP protocol with a new form of UPDATE messages. The actual route changes are then undertaken delayed by a few minutes in time from the announcement, this being able to be undertaken in the way provided for in conventional methods in the BGP protocol. The time delay is selected so that an optimum route is determined as a rule before the route change and a resource reservation can be undertaken. Since an average convergence process in inter-domain routing takes about 3 minutes, a time delay of a few minutes makes sense. This enables the convergence phase and the resource reservation for QoS traffic to be given priority in the period of time between the announcement and the actual rerouting. The rerouting is only delayed in relation to the announcement if the convergent route is already known and the resources needed have already been provided. Route announcements are transported by means of UPDATE messages and undergo the same convergence process as regular UPDATE messages, however do not change the traffic flow but initiate the determination of the later convergent route.

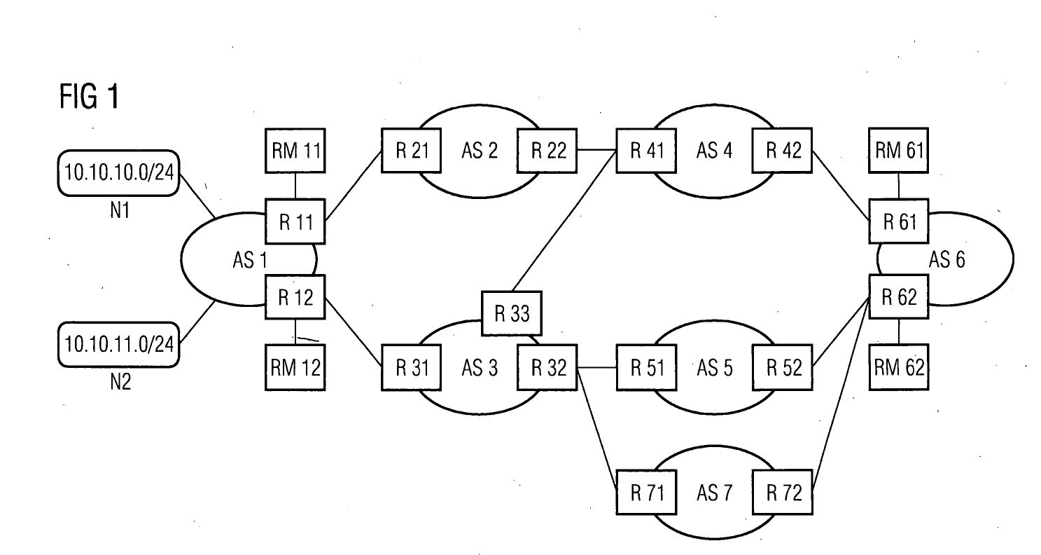

In accordance with the invention new attributes are used in BGP UPDATE messages, with which a route change can be announced in advance with an UPDATE message U1 (this route announcing message is also referred to as an announcement below). I.e. the attributes identify the UPDATE message as an announcement of a route change. Then, at an end time given in the announcement U1 (in the order of magnitude of minutes after the sending of U1), as provided for within the framework of the BGP protocol, the rerouting is initiated with a regular second UPDATE message U2. In the usual way the UPDATE message U2 contains the prefixes which can be reached and the AS path, i.e. the IP addresses of the accessible systems and the list of the autonomous systems leading to the destination. The UPDATE message U1 which is used as the announcement contains the same information as U2 and additional specifications: an indicator that an announcement of an incoming new route is involved, the time at which actual route change is to be initiated with the second UPDATE message U2 and also the address of a resource manager responsible for the resource reservations. In the example this resource manager is localized in the autonomous system which originally announces the route change with the UPDATE message U1. This resource manager is localized in the example given in FIG. 1 at the border router R12. A resource manager can for example be implemented with the aid of software by processes which run on a router or on an independent hardware platform. A central resource management is also possible.

The announcement U1 and all announcements derived from it in the subsequent course of execution undergo the usual selection processes at each border router, e.g. filter for incoming UPDATEs, selection of the best route (‘best path selection’) and filter for outgoing UPDATEs which decides on the route selection and forwarding, without however changing the existing routing of the traffic affected by the activation of the announced route. In accordance with the BGP protocol a maximum of one route to each destination—the best route—is forwarded to neighboring nodes. This restriction does not influence the forwarding of announced routes. Announced routes, once they have successfully passed through the selection process and are also modified like similar regular routes, are forwarded to all neighbors, as are the routes later initiated or activated by the UPDATE message U2. Announcements however do not influence the current best route of the traffic involved used for routing, especially do not change the corresponding entry in routing tables (FIB (forwarding information base)) and do not replace any routes learned via regular UPDATE messages. Like the UPDATE message U2 later, the announcement U1 thus triggers convergence processes. A remote autonomous system B, which will later react to U2 and will divert QoS traffic, undergoes a convergence process and already learns the routes available later and especially the convergent routes to be selected later, onto which the traffic will then be diverted. After an appropriate period of time and before the time at which U2 is sent which is known from the announcements, the autonomous system B reserves the resources needed for the diversion of the traffic involved on the convergent, best future route learned from the announcements. For this a corresponding signaling message is sent to the resource manager of the autonomous system A named in the announcement U1. To make this possible, all autonomous systems involved in the forwarding of the announced routes have created a route with a suitable prefix of the IP address of the resource manager. This means that the signaling message to the resource manager in the autonomous system A is generally already being sent over the new best path. If the UPDATE message U2 is then sent at the announced time, all autonomous systems react as previously, i.e. implementing routing for the traffic involved along the new route. Those autonomous systems which already know from the announcement phase that they are diverting traffic onto a new route wait for the arrival of the already known convergent route. Only then do they modify their routing tables (FIBs: forwarding information bases) and forward a corresponding UPDATE message.

FIG. 1 shows seven autonomous systems AS1, AS2, . . . , AS7. Two networks, network N1 and network N2, are connected to AS1. In network N1 the end systems can be reached with the IP addresses in the address block 10.10.10.0/24, i.e. 10.10.10.0 through 10.10.10.255, in network N2 the end systems can be reached with the addresses in the address block 10.10.11.0/24, i.e. 10.10.11.0 through 10.10.11.255. In this case 10.10.10.0/24 specifies an IP address, 10.10.10.0, and a mask length, 24, and stands for all IP addresses which match the specified address 10.10.10.0 in the first 24 bits (mask length), i.e. 10.10.10.0 through 10.10.10.255. Only some of the routers involved are shown in FIG. 1, the border routers via which the autonomous systems are connected to each other: R11, R12, R21, R22, R31, R32, R33, R41, R42, R51, R52, R61, R62, R71 and R72. Also only partly shown are the components responsible for resource management. As indicated by the typical resource managers RM11, RM12, RM61 and RM62 each border router is especially assigned a resource manager here.

Routes are shown in this example in the form (P, a1, a2, . . . , aN). In this case the prefix P describes the address block with the reachable destination addresses and the following sequence a1, a2, . . . , aN the sequence of the autonomous systems to be passed through via which the traffic reaches the destination addresses from P. For example (10.10.10.0/23, 4, 2, 1) is a route from the autonomous system AS6. It leads with the address block 10.10.10.0/23 to the networks N1 and N2. The character sequence 4, 2, 1 stands for the sequence of the autonomous systems: AS4, AS2, AS1 which forward the traffic from the autonomous system AS6 to the networks N1 and N2.

Assuming that autonomous system AS6 uses the route (10.10.10.0/23, 4, 2, 1) for the traffic to the destination networks N1 and N2, the load on the connection between the routers R21 and R11 is approaching the capacity limit and the autonomous system AS1 would like to divert a part of the traffic onto other routes. It is further assumed that the autonomous system AS1 decides to divert the traffic to network N2 on routes via R12.

According to the previous method, that is within the framework of the BGP protocol, without the new inventive method, the router R11 would restrict the destination addresses which can be accessed via it with an UPDATE message to 10.10.10.0/24 and notify the router R12 with an UPDATE message about the accessibility 10.10.11.0/24. This would initiate a convergence process generally lasting three minutes on average, during which the quality-of-service for traffic streams from the autonomous system AS6 to the networks N1 and N2 suffers considerably and possibly during the convergence process resources are reserved in number of times on different paths between the autonomous systems AS6 and AS1.

In accordance with the new inventive method the router R12 sends an UPDATE message U1 to the router R31 which contains an announcement of the route (10.10.11.0/24, 1). U1 could contain the fact that this route will be notified as a binding route in 10 minutes with a further UPDATE message. AS3 propagates the announced route as (10.10.11.0/24, 3, 1) to routers R41, R51 and R71. The autonomous system AS4 propagates the announced route as (10.10.11.0/24, 4, 3, 1) to the autonomous system AS6 although the router R42 has already forwarded (10.10.10.0/23, 4, 3, 1) to router R61. The convergence phase is completed in this example when (10.10.11.0/24, 4, 3, 1) via router R42, (10.10.11.0/24, 5, 3, 1) via router R52 and (10.10.11.0/24, 7, 3, 1) via router R72 have arrived in the autonomous system AS6 and the autonomous system AS6 has selected what it sees as the best route. It is assumed here that the autonomous system AS6 decides on (10.10.11.0/24, 5, 3, 1), e.g. because this is the optimum route in the sense of a metric. With the announced routes the autonomous system AS6 also finds out about the switchover time intended by the autonomous system AS1. Taking into account the fact that the clocks of the autonomous systems AS1 and AS6 are not running synchronously, the autonomous system AS6 will inform its resource management in good time about its choice of route and cause the resource manager RM62 to signal the required resources on the selected future route to the resource manager RM12. This means that the new route is defined and the required resources are already provided when router R12 sends at the announced time a further UPDATE message U2 with the route (10.10.11.0/24, 1) to router R31, this time as a regular UPDATE message. In a sequence which cannot be defined beforehand, triggered by the U2 UPDATE, messages with the routes (10.10.11.0/24, 4, 3, 1), (10.10.11.0/24, 5, 3, 1) and (10.10.11.0/24, 7, 3, 1) will arrive at the autonomous system AS6. The autonomous system AS6 already knows the new convergent route and will now wait until such time as the UPDATE message with the route (10.10.11.0/24, 5, 3, 1) arrives. The autonomous system AS6 will then adapt its routing and put the traffic to N2 on to a new path which is already available as an end-to-end path at this point, represents the convergence state and provides the necessary resources. Without significant adverse effects on the quality of service this diverts the traffic to the new route (except for possible overlaps of traffic on the new link and traffic still running on the old link which has not yet reached its destination at the time of the rerouting). Subsequently the resource manager RM61 will adapt the resources reserved on the old route via the autonomous systems AS4, AS2 and AS1, i.e. release the resources no longer needed because of the traffic diversion.

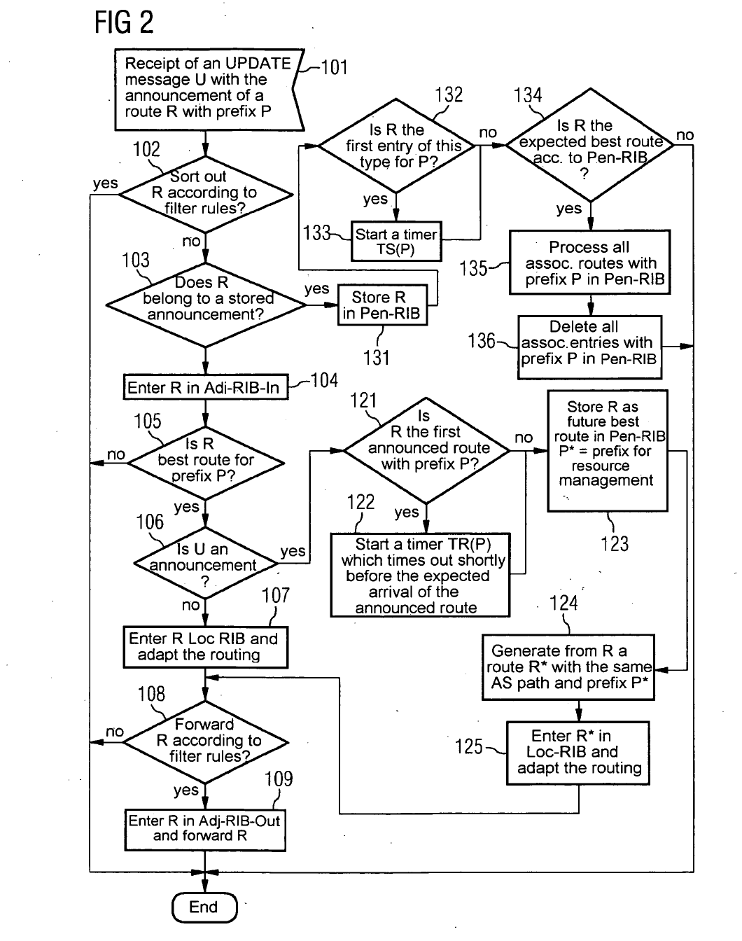

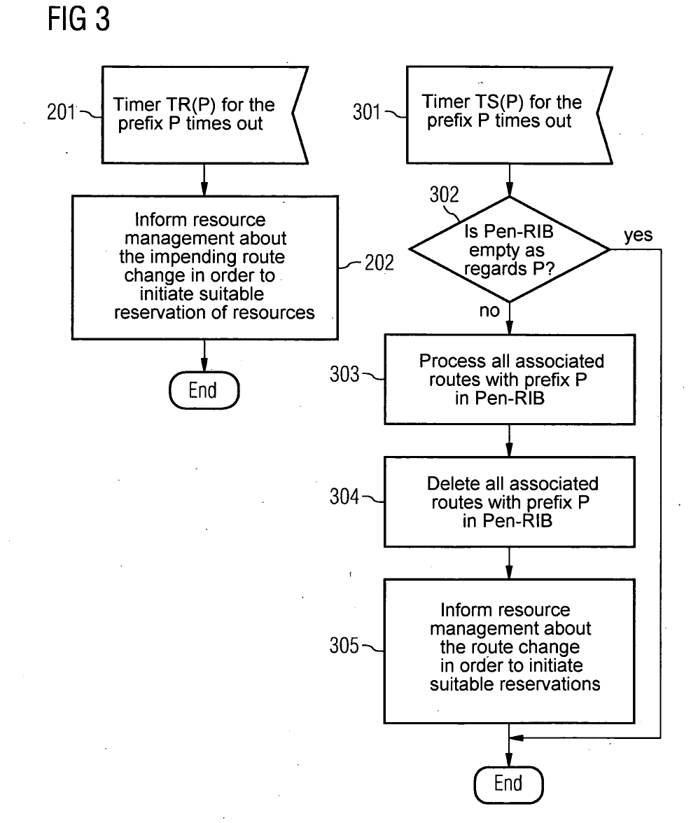

The autonomous system AS6 proceeds in this case according to the flowchart shown in FIG. 2 and FIG. 3. For the sake of simplification it is assumed here that an UPDATE only contains an announced route R with prefix P (step 101). An expansion for UPDATE messages which announces a number of routes is of no importance to the person skilled and the art. Steps 102, 104, 105, 107, 108 and 109 correspond to the processing of announced routes described in RFC1771. In step 106 route announcements are filtered out in this sequence which in future describe the best routes and are stored in a new database for announced routes, Pen-RIB (Pen stands for Pending), (step 123), if R is the first such route announcement for the prefix P (not entered in Pen-RIB) a timer is started (step 121 and 122). A route R* is generated from the route announcement R which is identical to R except for the prefix P* (step 124). P* is the prefix of the resource manager responsible for reservations on the announced route with the prefix R, in the example a prefix for an address of RM12 in AS1. R* is now entered in Loc-RIB and activated instead of the route announcement (step 125).

Announced routes which are expected as a result of the route announcements entered in Pen-RIB are filtered out in step 103 and given special treatment. They are entered in the database Pen-RIB (step 131). With the first such entry a timer is started (step 132 and 133). If the route R corresponds to the new best route contained in the Pen-RIB, all routes buffered in the Pen-RIB for the prefix P are processed and all entries for the prefix P in Pen-RIB deleted (step 134, 135 and 136). The processing in step 135 corresponds to that of steps 104, 105, 107, 108 and 109.

If a timer set in step 122 times out (step 201) the resource management is informed about an impending change of route in order to initiate a corresponding resource reservation (step 202). If a timer set in step 133 times out (step 301) it is assumed that the new best route stored in Pen-RIB is no longer valid. A check is made as to whether there are entries for the prefix P in Pen-RIB (step 302). If there are, all the routes buffered for prefix P in Pen-RIB are processed (step 303) and deleted in Pen-RIB (step 304). Furthermore the resource management is informed about the change (step 305).

If it is to be assumed that route changes initiated by a number of autonomous systems for the same prefix must be held in Pen-RIB, the entries in Pen-RIB must be made according to prefix and an identification of the sender of the original announcement (AS1 or router R12 in the example) must be provided. To this end route change messages must where necessary also provide a suitable value for this identification, e.g. an AS number or a IP address of a border router.

1.-19. (canceled)

20. A method for defining a route in a data network with a network element for routing data traffic, comprising:
sending a message to the network element to announce a route;
causing the network element to route the data traffic by an event, that is time-delayed to the message send; and
routing the data traffic based upon the announced route.

21. The method as claimed in claim 20, wherein the event is a message for a route activation.

22. The method as claimed in claim 21, wherein:
the network element is receiving a route modification message,
a timer is started after receiving the route modification message, and
the route modification is putted into operation after the timer times out.

23. The method as claimed in claim 22, wherein the route is defined based upon an inter-domain routing.

24. The method as claimed in claim 23, wherein the route is defined based upon a Border Gateway Protocol.

25. The method as claimed in claim 20, wherein:
the data traffic is routed to a destination,
a plurality of routes to the destination are announced, and
an optimum route based upon a metric is selected before the occurrence of the event.

26. The method as claimed in claim 20, wherein the event is based upon an UPDATE message of the Border Gateway Protocol.

27. The method as claimed in claim 20, wherein a resource reservation to network elements is initiated based upon the announced route.

28. The method as claimed in claim 27, wherein the network element is assigned to a resource management and the resource management is sent to a resource reservation message along the announced route to make reservation for data traffic.

29. The method as claimed in claim 28, wherein the resource management has an address and the address is sent to a network element based upon the message announcing the route.

30. The method as claimed in claim 28, wherein resource reservation messages are transmitted along the announced route for route reservation.

31. The method as claimed in claim 28, wherein a successful resource reservation is confirmed to the network element.

32. The method as claimed in claim 28, wherein with an unsuccessful resource reservation the routing of data traffic is desisted.

33. The method as claimed in claim 32, wherein a route activation message is not send to the network element if the resource reservation fails.

34. The method as claimed in claim 20, wherein the route announcing message has an indicator to be identified as a route announcing message.

35. The method as claimed in claim 34, wherein the route announcing message comprises information about the arrival time of the event.

36. The method as claimed in claim 35, wherein the route announcing message comprises at least one address of a resource management device.

37. The method as claimed in claim 36, wherein the route announcing message is based upon the structure of an UPDATE message of a Border Gateway Protocol.

38. The method as claimed in claim 28, wherein the data traffic is transmitted within certain quality-of-service features.

39. Network element for routing data traffic in a data network comprising a timer and a resource manager to manage network resources.
